(19) United States
(12) Patent Application Publication
(10) Pub. No.: US 2013/0060600 A1
(43) Pub. Date: Mar. 7, 2013

(54) RISK REPORTING LOG

(71) Applicant: Parr Thomas Schoolman, Aurora, IL (US)

(72) Inventor: Parr Thomas Schoolman, Aurora, IL (US)

(73) Assignee: Aon Benfield Global, Inc., Chicago, IL (US)

(21) Appl. No.: 13/253,420

(22) Filed: Oct. 5, 2011

Related U.S. Application Data
(60) Provisional application No. 61/531,437, filed on Sep. 6, 2011.

(51) Int. Cl. G06Q 10/00

(52) U.S. Cl. 705/7.28

(57) ABSTRACT

Risk organizing and tracking systems are provided. Users may enter risks relevant to a business entity and associate one or more parameters. The parameters may be chosen from a default list or created by a user. A risk scoring algorithm may also be selected or provided. Scores for the risks may then be generated using the risk scoring algorithm.

The present application claims priority to U.S. provisional patent application Ser. No. 61/531,437, entitled Risk Reporting Log and filed on Sep. 6, 2011. The entire disclosure of which is hereby incorporated by reference.

### FIELD OF THE INVENTION

This invention relates generally to systems and methods for organizing and managing risk information. More particularly, aspects of the invention provide methods and systems for generating a risk reporting log that includes options for scoring risks.

### DESCRIPTION OF RELATED ART

Business entities face a large number of risks that can impact profit margins and even existence. Exemplary risks include those relating to natural disasters, supply chains, manufacturing, reputation of brands and products and labor. It can be difficult for business managers and others to organize and track risks. Some prior art attempts have included listing risks on spreadsheets. It is not uncommon for different business units within the same enterprise to use unique spreadsheet formats. The use of different format across an enterprise makes it difficult to track risks. Prior systems designed to track risk have also had limited risk scoring capabilities.

Therefore, there is a need in the art for improved systems and methods for organizing and tracking risks.

### BRIEF SUMMARY OF THE INVENTION

Aspects of the invention overcome problems and limitations of the prior art by providing flexible systems and methods for organizing and tracking risks. Users may identify risks relevant to a business entity and either select or create corresponding parameters. Risk scoring algorithms may also be selected or created. Scores may then be generated with a scoring algorithm and the parameters.

In some embodiments users enter information with a conventional Internet browser. The information may ultimately be received at a server or other computer device. The server or other computer device may store and process the information provided. The server may also transmit information, images and graphical user interface elements to the Internet browser.

Additional or alternative embodiments may be partially or wholly implemented on a computer-readable medium, for example, by storing computer-executable instructions or modules, or by utilizing computer readable data structures.

Of course, the methods and systems of the above-referenced embodiments may also include other additional elements, steps, computer-executable instructions or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings and from the claims.

### BRIEF DESCRIPTION OF THE DRAWINGS

The present invention is illustrated by way of example and not limited in the accompanying figures in which like reference numerals indicate similar elements and in which:

FIG. 1 illustrates an exemplary prior art computer system and network that may be used to implement aspects of the invention.

FIG. 2 illustrates a process that may be performed to organize risk data in accordance with an embodiment of the invention.

FIG. 3 shows a screen that identifies risk parameters in accordance with an embodiment of the invention.

FIG. 4 illustrates an exemplary screen that may be used to select footprint parameters in accordance with an embodiment of the invention.

FIG. 5 illustrates a screen that may be used to enter data that includes initiatives and controls.

FIG. 6 illustrates how a control may be used to impact a business entity risk score in accordance with an embodiment of the invention.

FIG. 7 illustrates an exemplary screen that may be used to generate reports in accordance with an embodiment of the invention.

### DETAILED DESCRIPTION

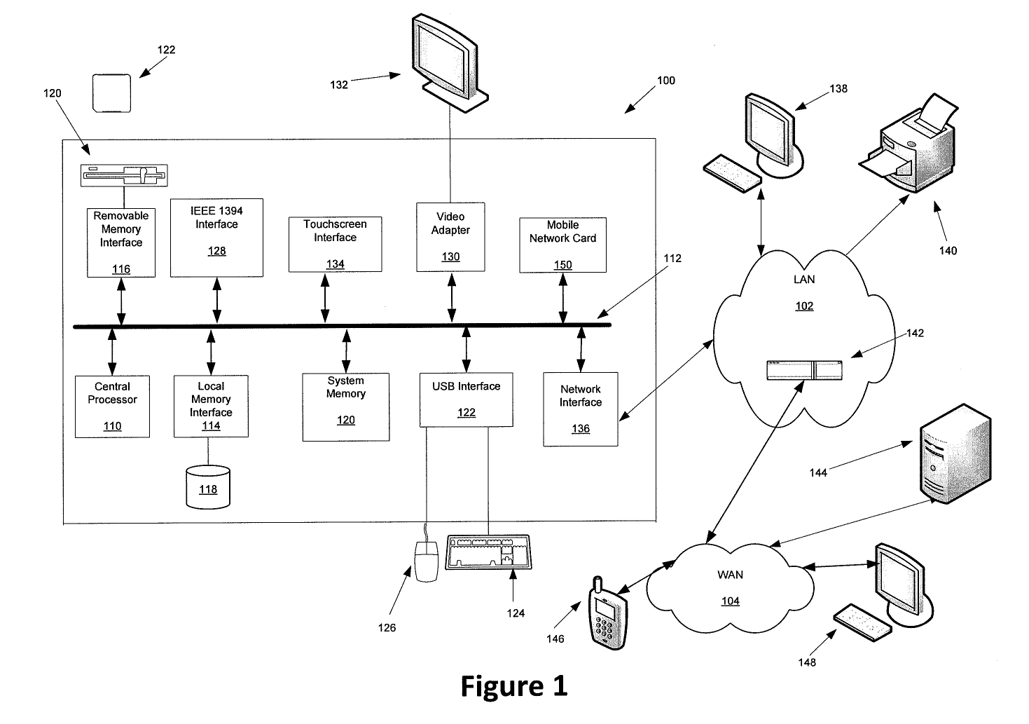

Various embodiments of the invention may be implemented with computer devices, computer networks and systems that exchange and present information. Elements of an exemplary computer system are illustrated in FIG. 1, in which the computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives that receive removable memory elements 122. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 120, generally read and write data electronically and do not include read/write heads. System memory 120 may be implemented with a conventional system memory having a read only memory section that stores a basic input/output system (BIOS) and a random access memory (RAM) that stores other data and files.

A user can interact with computer 100 with a variety of input devices. FIG. 1 shows a universal serial bus (USB) interface 122 coupling a keyboard 124 and a pointing device 126 to system bus 112. Pointing device 132 may be implemented with a hard-wired or wireless mouse, track ball, pen device, or similar device.

Computer 100 may include additional interfaces for connecting peripheral devices to system bus 112. FIG. 1 shows a IEEE 1394 interface 128 that may be used to couple additional devices to computer 100. Peripheral devices may include game pads scanners, printers, and other input and output devices and may be coupled to system bus 112 through parallel ports, game ports, PCI boards or any other interface used to couple peripheral devices to a computer.

Computer 100 also includes a video adapter 130 coupling a display device 132 to system bus 112. Display device 132 may include a cathode ray tube (CRT), liquid crystal display (LCD), field emission display (FED), plasma display or any other device that produces an image that is viewable by the user. A touchscreen interface 134 may be included to couple a touchscreen (not shown) to system buss 112. A touchscreen may overlay at least part of the display region of display device 132 and may be implemented with a convention touchscreen technology, such as capacitive or resistive touchscreen technology.

One skilled in the art will appreciate that the device connections shown in FIG. 1 are for illustration purposes only and that several of the peripheral devices could be coupled to system bus 112 via alternative interfaces. For example, a video camera could be connected to IEEE 1394 interface 128 and pointing device 126 could be connected to another interface.

Computer 100 may include a network interface 136 that couples system bus 112 to LAN 102. LAN 102 may have one or more of the well-known LAN topologies and may use a variety of different protocols, such as Ethernet. Computer 100 may communicate with other computers and devices connected to LAN 102, such as computer 138 and printer 140. Computers and other devices may be connected to LAN 102 via twisted pair wires, coaxial cable, fiber optics or other media. Alternatively, electromagnetic waves, such as radio frequency waves, may be used to connect one or more computers or devices to LAN 102.

A wide area network 104, such as the Internet, can also be accessed by computer 100. FIG. 1 shows network interface 136 connected to LAN 102. LAN 102 may be used to connect to WAN 104. FIG. 1 shows a router 142 that may connect LAN 102 to WAN 104 in a conventional manner. A server 144. Mobile terminal 146 and a computer device 148 are shown connected to WAN 104. Of course, numerous additional servers, computers, handheld devices, personal digital assistants, telephones and other devices may also be connected to WAN 104.

In some embodiments, a mobile network card 150 may be used to connect to LAN 102 and/or WAN 104. Mobile network card may be configured to connect to LAN 102 and/or WAN 104 via a mobile telephone network in a conventional manner.

The operation of computer 100 and server 144 may be controlled by computer-executable instructions stored on a computer-readable medium. For example, computer 100 may include computer-executable instructions for transmitting information to server 144, receiving information from server 144 and displaying the received information on display device 132. Furthermore, server 144 may include computer-executable instructions for, receiving requests from computer 100, processing data and transmitting data to computer 100. In some embodiments server 144 transmits hypertext markup language (HTML) and extensible markup language (XML) formatted data to computer 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102 and 104, but also a “content network,” which is comprised of the data—attributable to a single entity—which resides across all physical networks.

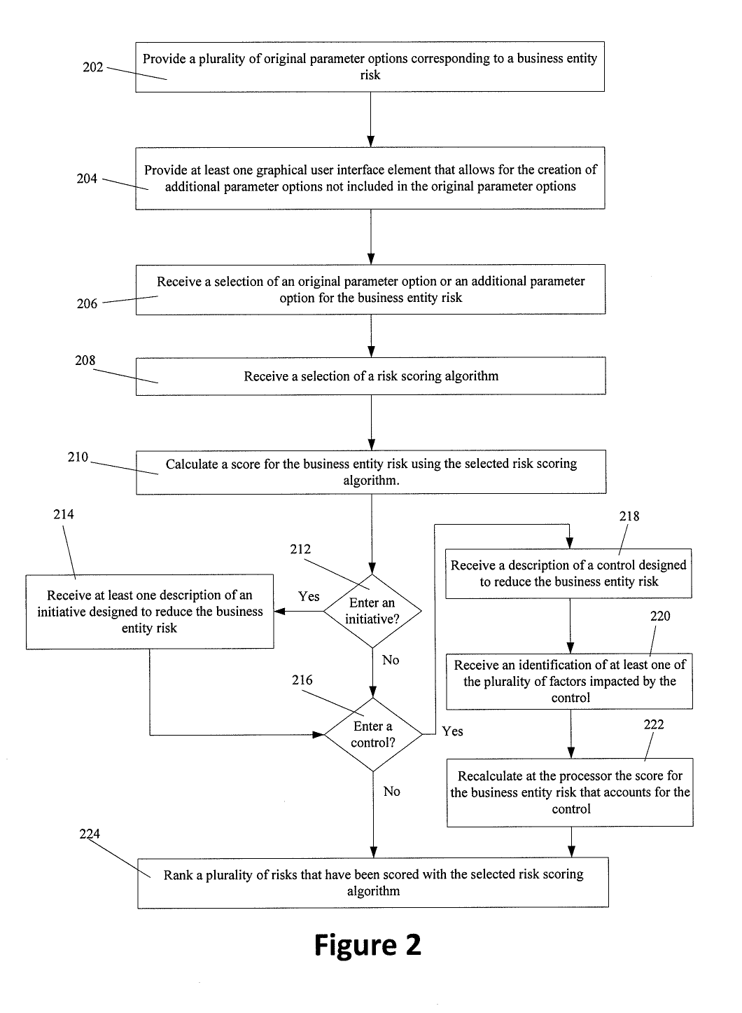

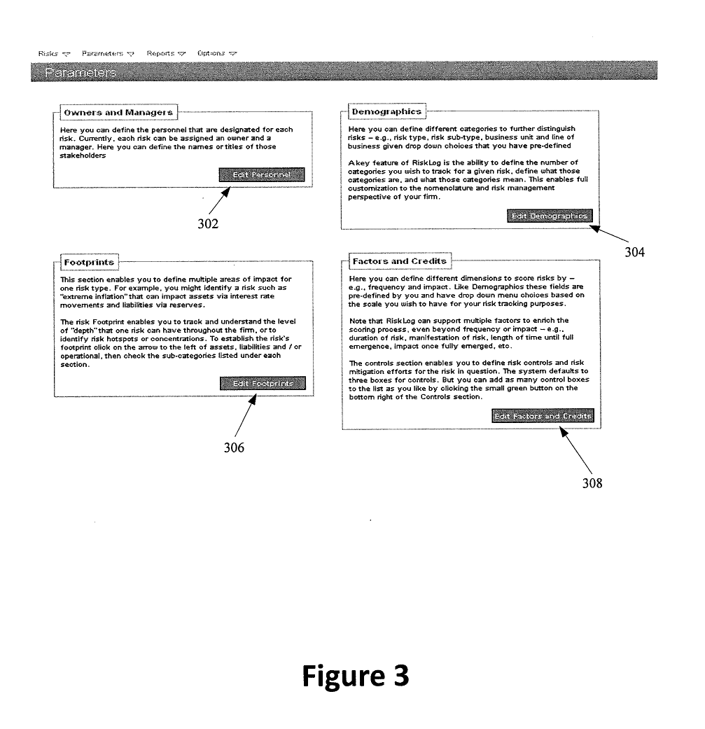

FIG. 2 illustrates a process that may be performed to organize risk data, in accordance with an embodiment of the invention. At least some parts of the process may be performed on a computer device, such as a server. The process may be implemented with computer-executable instructions and the server may provide access to users via conventional browser applications. First, in step 202 a plurality of original parameter options corresponding to a business entity risk are provided. In step 204 at least one graphical user interface element that allows for the creation of additional parameter options not included in the original parameter options is provided. Risk parameter options may include the identification of owners and managers, footprints, demographics and factors and credits. FIG. 3 shows a screen that identifies risk parameters in accordance with an embodiment of the invention. Owners and managers may be the personnel that are designated for each risk. Footprints may correspond to impact areas for a given risk type. An extreme inflation risk may have a footprint that includes assets impacted by interest rate movements. Demographics can be selected to further distinguish risk types. Exemplary demographics include risk sub-types and business units. Step 202 may include transmitting the types of parameters shown in FIG. 2 from a server, such as server 144, to a computer device. Step 204 may include transmitting one or more of graphical user interface elements 302, 304, 306 and 308 from the server to a computer device. Graphical user interface elements 302, 304, 306 and 308 may be selected to create new parameters and provide flexibility to users of the system.

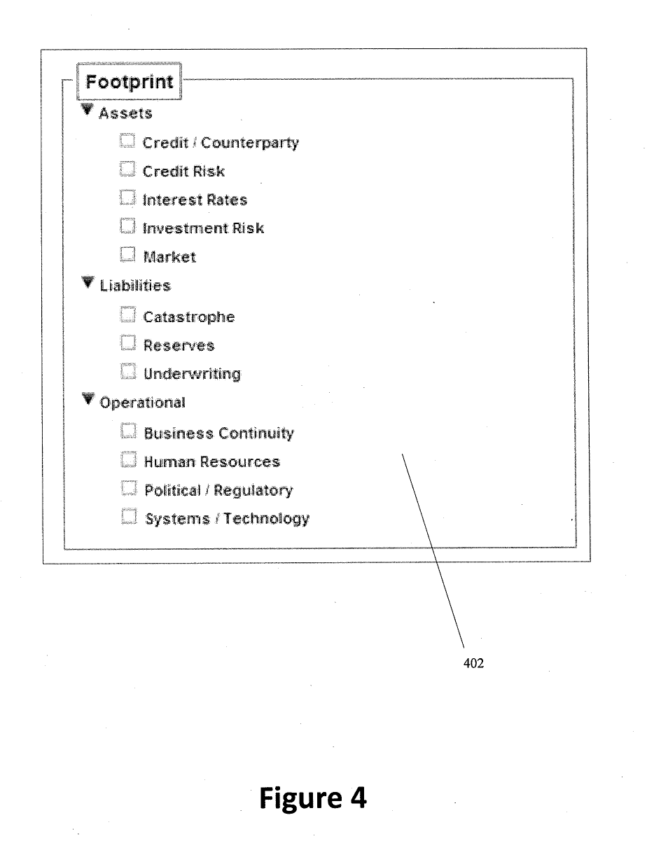

In step 206 a computer device may receive a selection of an original parameter option or an additional parameter option for the business entity risk. FIG. 4 illustrates an exemplary screen that may be used to select footprint parameters 402. Screen 402 may be updated with new parameters when a user creates new parameters. A user may make a selection by interacting with the appropriate graphical user interface element. The selection may then be received at a server or other computer device. The selection of other parameters may be performed with similar or other well-known graphical user interface elements.

In various embodiments users may be provided with multiple algorithms to score risks. The algorithms may be based one or more factors. Exemplary factors include the frequency of the risk occurring, the duration of an event, an impact of the event and risk severity. Algorithms may include addition of factors, multiplication of factors, squaring of factors or other combinations of factors. In some embodiments users may create new algorithms. In step 208 a selection of a risk scoring algorithm is received. A user may enter the selection at a computer device and the selection may ultimately be received at a server or other computer device. A score for the business entity risk may be calculated using the selected risk scoring algorithm in step 210.

In some embodiments initiatives and controls may also be tracked and organized. In step 212 it is determined whether an initiative will be entered. A user may select an appropriate menu option and a corresponding selection may be received at a computer device. When an initiative will be entered, in step 214 at least one description of an initiative designed to reduce the business entity risk is received. The description may be received at a computer device. After step 214 or when an initiative will not be received, control passes to step 216 where it is determined whether a control will be entered. When a control will be entered, in step 218 a description of a control designed to reduce the business entity risk is received. In step 220 an identification of at least one of a plurality of factors impacted by the control is received. The factors impacted by the control may be factors used in scoring a business entity risk, such as the frequency of the risk occurring, the duration of an event, an impact of the event and risk severity.

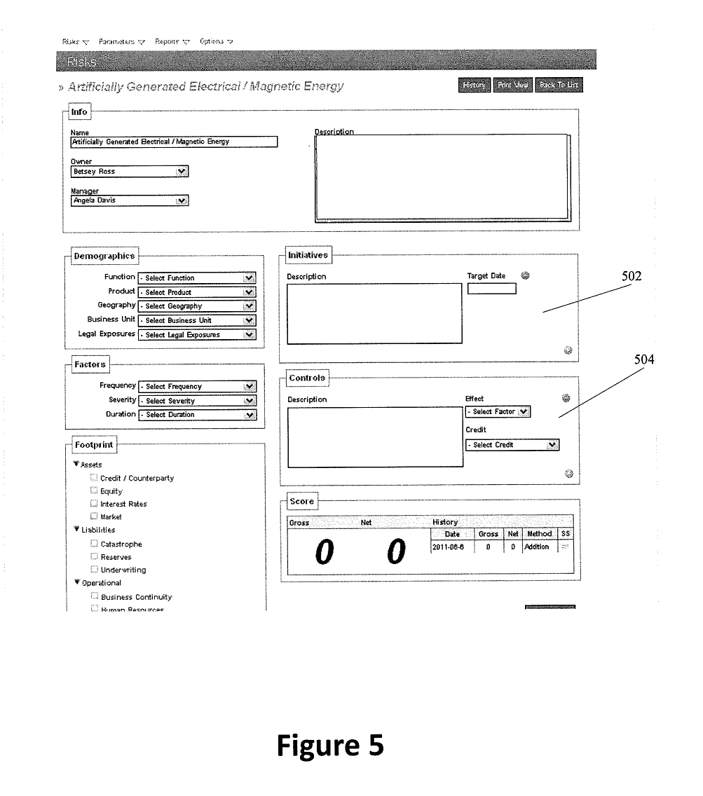

FIG. 5 illustrates a screen that may be used to enter information that includes initiatives and controls. Section 502 includes text boxes for descriptions of initiatives and target dates. Section 504 includes a text box for entering a description of a control and menu items that may be used to select an appropriate factor impacted by the control and a credit amount. Credit amounts are described below. The information entered into the screen shown in FIG. 5 may ultimately be received at a server or other computer device.

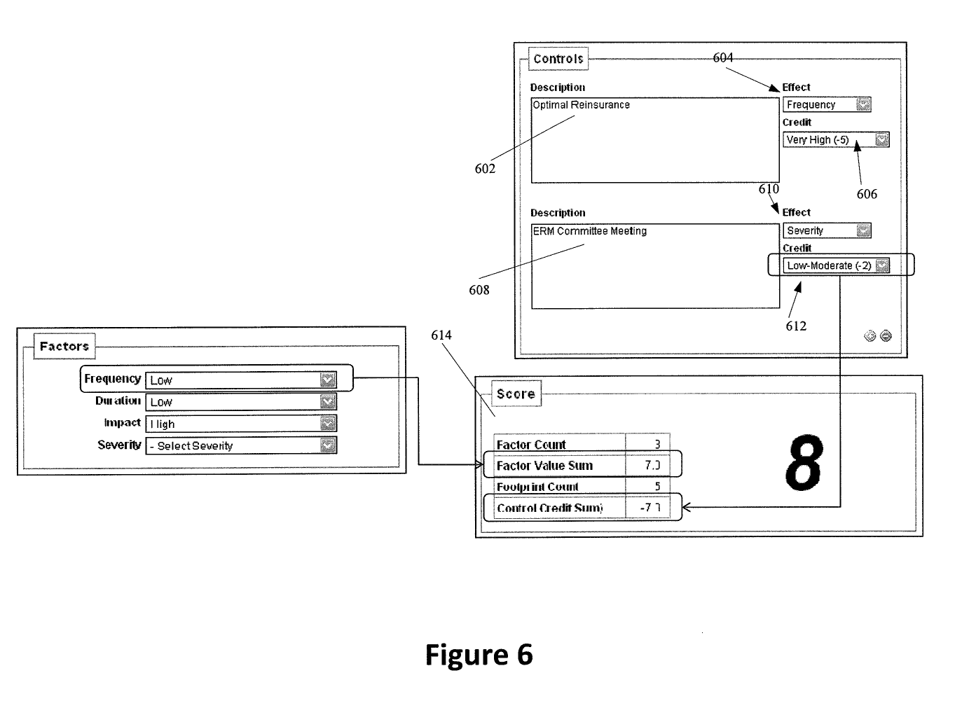

Returning to FIG. 2, after step 222, the score for the business entity risk that accounts for the control may be recalculated. FIG. 6 illustrates how a control may be used to impact a business entity risk score in accordance with an embodiment of the invention. A first control is described as “Optimal Reinsurance” in text box 602. A selection was made at drop down menu 604 to show that the control impacts the frequency parameter. A selection was also made at a drop down menu 606 to show that the control will apply a credit of “5” to the score. Similarly, a second control is described as “ERM Committee Meeting” in text box 608. A selection was made at drop down menu 610 to show that the control impacts the severity parameter and a selection was also made at a drop down menu 612 to show that the control will apply a credit of “2” to the score. The score of “8” in section 614 accounts for the combined credits of “7.”

After step 222 or when no control will be entered, in step 224 a plurality of risks that have been scored with the selected risk scoring algorithm may be ranked. Rankings may be used by managers to identify the largest risks.

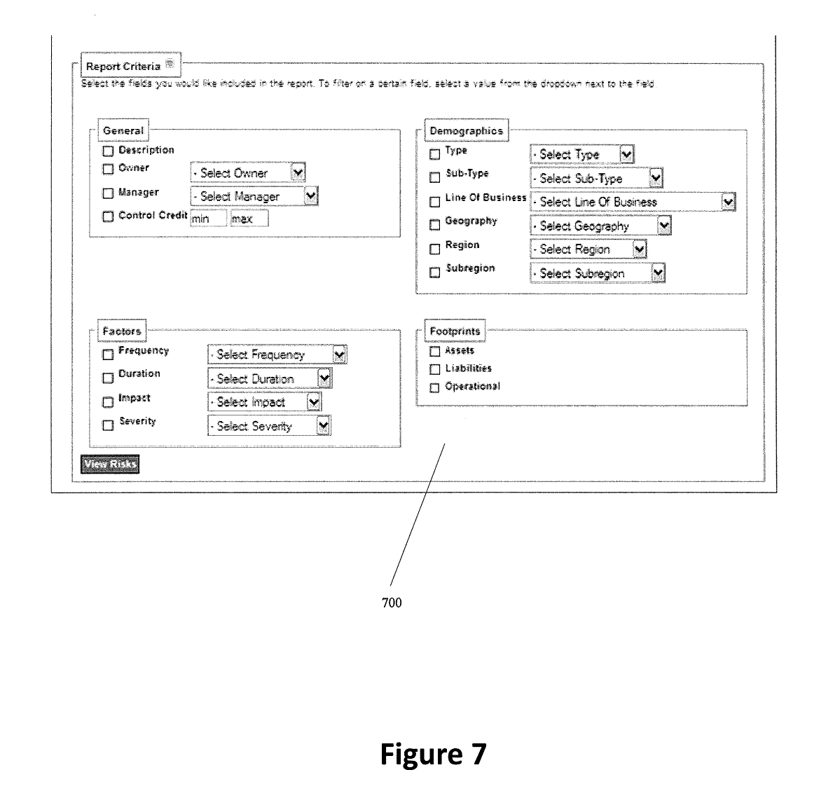

Reports of risks and associated parameters may also be generated with embodiments of the invention. FIG. 7 illustrates an exemplary screen 700 that may be used to generate reports in accordance with an embodiment of the invention. Risks and associated parameters may be stored in a database. The information entered in screen 700 may be used to query the database to retrieve appropriate risks and associated parameters.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

We claim:

1. A method of organizing risk data, the method comprising:
(a) providing a plurality of original parameter options corresponding to a business entity risk;
(b) providing at least one graphical user interface element that allows for the creation of additional parameter options not included in the original parameter options;
(c) receiving at a processor a selection of an original parameter option or an additional parameter option for the business entity risk; and
(d) receiving at a processor a selection of a risk scoring algorithm.

2. The method of claim 1, further including
(e) calculating at a processor a score for the business entity risk using the selected risk scoring algorithm.

3. The method of claim 2, further including
(f) receiving at least one description of an initiative designed to reduce the business entity risk.

4. The method of claim 1, wherein the algorithm identifies a plurality of factors.

5. The method of claim 4, further including:
(e) receiving a description of a control designed to reduce the business entity risk; and
(f) receiving an identification of at least one of the plurality of factors impacted by the control.

6. The method of claim 5, further including:
(g) recalculating at the processor the score for the business entity risk that accounts for the control.

7. The method of claim 4, wherein one of the plurality of factors comprises a frequency of the risk occurring.

8. The method of claim 4, wherein one of the plurality of factors comprises a duration.

9. The method of claim 4, wherein one of the plurality of factors comprises an impact.

10. The method of claim 4, wherein one of the plurality of factors comprises a risk severity.

11. The method of claim 1, wherein the risk identifying parameters comprise demographic information.

12. The method of claim 11, wherein the risk identifying parameters comprise footprint information.

13. The method of claim 1, further including:
(e) at a processor ranking a plurality of risks that have been scored with the selected risk scoring algorithm.

14. The method of claim 1, wherein the selected risk scoring algorithm comprises a multiplication of factors algorithm.

15. The method of claim 1, further including
(e) transmitting a graphical user interface selection element that includes risk scoring algorithm options that include (i) addition of factors, (ii) multiplication of factors and (iii) squaring of factors.

16. A non-transitory computer-readable medium containing computer-executable instructions that when executed cause a computer device to perform the steps comprising:
(a) receiving risk identifying parameters for a business entity risk;
(b) receiving a selection of a risk scoring algorithm; and
(c) calculating a score for the business entity risk using the selected risk scoring algorithm.

17. The non-transitory computer-readable medium of claim 16, further including computer executable instructions that when executed cause a computer device to perform the step comprising:
(d) transmitting a graphical user interface selection element that includes risk scoring algorithm options that include (i) addition of factors, (ii) multiplication of factors and (iii) squaring of factors.

18. The non-transitory computer-readable medium of claim 17, further including computer executable instructions that when executed cause a computer device to perform the step comprising:
(e) ranking a plurality of risks that have been scored with the selected risk scoring algorithm.

19. The non-transitory computer-readable medium of claim 16, further including computer executable instructions that when executed cause a computer device to perform the steps comprising:
(d) receiving a description of a control designed to reduce the business entity risk;
(e) receiving an identification of at least one of the plurality of factors impacted by the control; and
(f) recalculating at the processor the score for the business entity risk that accounts for the control.

20. A computer device comprising:
a processor;
a memory containing computer-executable instructions that when executed by the processor cause the computer device to perform the steps comprising:
(a) providing a plurality of original parameter options corresponding to a business entity risk;
(b) providing at least one graphical user interface element that allows for the creation of additional parameter options not included in the original parameter options;
(c) receiving a selection of an original parameter option or an additional parameter option for the business entity risk; and
(d) receiving a selection of a risk scoring algorithm.

21. The computer device of claim 20, wherein the memory includes further computer-executable instructions that cause the computer device to perform the steps comprising:
(e) calculating a score for the business entity risk using the selected risk scoring algorithm.

22. The computer device of claim 21, wherein the memory includes further computer-executable instructions that cause the computer device to perform the steps comprising:
(f) generating a graphical user interface selection element that includes risk scoring algorithm options that include (i) addition of factors, (ii) multiplication of factors and (iii) squaring of factors.
